(19) United States
(12) Patent Application Publication
(10) Pub. No.: US 2004/0051324 A1
(43) Pub. Date: Mar. 18, 2004

(54) Magnetic sweeper with flux optimizing channel structure

(76) Inventor: Greg S. Snider, Medina, OH (US)

Correspondence Address: James C. Scott, Esq., Roetzel & Andress, 1375 E. 9th Street, One Cleveland Center, 10th Floor, Cleveland, OH, 44114, US

(21) Appl. No.: 10/244,311

(22) Filed: Sep. 16, 2002

(51) Int. Cl. B25J 15/06; B66C 1/04

(52) U.S. Cl. 294/65.5

(57) ABSTRACT

A magnetic tool for manipulated conveyance over a surface for magnetic collection of ferrous articles has a three-sided channel which cooperates with an opposing plate to form a magnet housing for one or more magnets. The magnetically conductive channel is configured to direct magnet flux downward to optimize the attraction efficiency of the tool. Magnetic flux is further optimized by use of two magnets in the channel housing of opposite polarity. The channel also serves as the primary structural element of the tool for attachment of conveyance and manipulation means.

### FIELD OF THE INVENTION

The present invention pertains generally to magnets and magnetic devices and, more particularly, to magnetic hand tools with functional features which cooperate with housed or mounted magnets.

### BACKGROUND OF THE INVENTION

Magnetic tools, such as hand tools, require some type of support structure or housing for magnetized material, and other functional aspects such as a grip, conveyance such as wheels or other mechanism for performance of the tool. The type and purpose of the tool dictates the mounting or housing structure for the magnet, with a primary operational concern being that the magnetic flux is directed in the desired orientation relative to the tool. For example, in a hand-held magnetic tool with some type of grip, it is desirable that the magnetic flux be directed generally away from the grip to maximize the operational efficiency of the tool. In a hand-operated magnetic sweeper, such as described for example in U.S. Pat. No. 6,158,792, designed to pick up ferrous objects off the floor, it is desirable to have the magnetic flux directed downward by the housing which supports and surrounds the magnet or magnets.

Directing magnetic flux in one general direction typically requires that the magnet or magnets be shrouded or otherwise encapsulated on all sides but the desired flux direction. The magnetic sweeper described in U.S. Pat. No. 6,158,792 has three-sided magnet housing, with the top side directing the flux downward through an aluminum channel which protects the front and underside of the magnet. This downwardly directed flux tends to attract ferrous object on the frontal surface of the magnet housing of the tool, rather than to the bottom surface of the magnet housing. The rear facing surface of the magnet is left exposed. U.S. Pat. No. 3,646,492 describes another type of magnetic sweeping device which has a three-sided magnet housing which leaves a bottom surface of the magnet exposed. While this may direct the magnetic flux downward, attraction of sharp objects directly against the exposed magnet may result in chipping, breaking or soiling of the magnet, resulting in diminished performance of the tool. In this design the three-sided channel which serves as the magnet housing is attached to a support structure which is in turn attached to a handle. This adds to the complexity of construction of the device.

### BRIEF SUMMARY OF THE INVENTION

The present invention provides a magnetic sweeper tool with an integrated construction which optimizes magnetic flux in a desired direction for maximum pick-up efficiency. In accordance with the principles of the invention, a magnetic sweeper has a three-sided channel which houses one or more magnets in a generally planar arrangement, with an open side of the channel being covered by a plate which covers the remaining exposed surface of the magnet(s). The channel serves both as the primary structural member of the magnetic sweeper tool, and to direct the magnetic flux downward away from the channel toward a floor surface over which the tool is conveyed by wheels or other conveyance. The plate covering the open side of the channel and the exposed surface of the magnet(s) is of a different, non-magnetic material than the channel, such as plastic, aluminum or stainless steel, so as to not short the magnetic circuit within the housing formed by the channel and plate. As the primary structural member of the tool, the channel further functions to support axles for mounting of wheels at opposite ends of the channel. This design avoids the need to attach the channel to a separate member or piece for attachment to wheels and a handle or other manipulation part. In one embodiment, a wheel axle is attached to a top side of the channel at each end. In another embodiment, a wheel axle is attached to an underside of the top of the channel at each end. A manipulation handle is attached directly to the channel, preferably at a mid-point along the top of the channel.

These and other aspects of the invention are described herein in detail with reference to the accompany Figures which are denoted with reference numbers associated with the various components, parts and assemblies of the invention.

### DESCRIPTION OF THE FIGURES

FIG. 1 is a perspective view of a magnetic sweeper tool of the present invention;

FIG. 2 is a perspective sectional view of a channel end and wheel mounting portion of the magnetic sweeper tool of the invention;

FIG. 3 is a perspective view of a portion of the magnetic sweeper tool of the invention;

FIG. 4 is a top view of the magnetic sweeper tool of the invention, with arrows indicating the directions of magnetic flux paths between the north and south poles, and

FIG. 5 is a cross-sectional view of a channel portion of the magnetic sweeper tool of the invention, with arrows indicating the directions of magnetic flux paths between the north and south poles.

### DESCRIPTION OF PREFERRED AND ALTERNATE EMBODIMENTS

With reference to FIG. 1, there is illustrated a magnetic sweeper tool 10 which includes the main component parts of a channel 12 which serves as a support structure and housing for a one or more magnets 18, and as a mounting structure for any type of conveyance, which in this case is in the form of wheels 15 mounted upon axles 13 at opposite distal ends 14 of the channel 12. The channel 12 can be made of any material of sufficient structural strength, but is preferably made of a ferrous, magnetically conductive material which directs the magnetic flux in the desired direction, as further described.

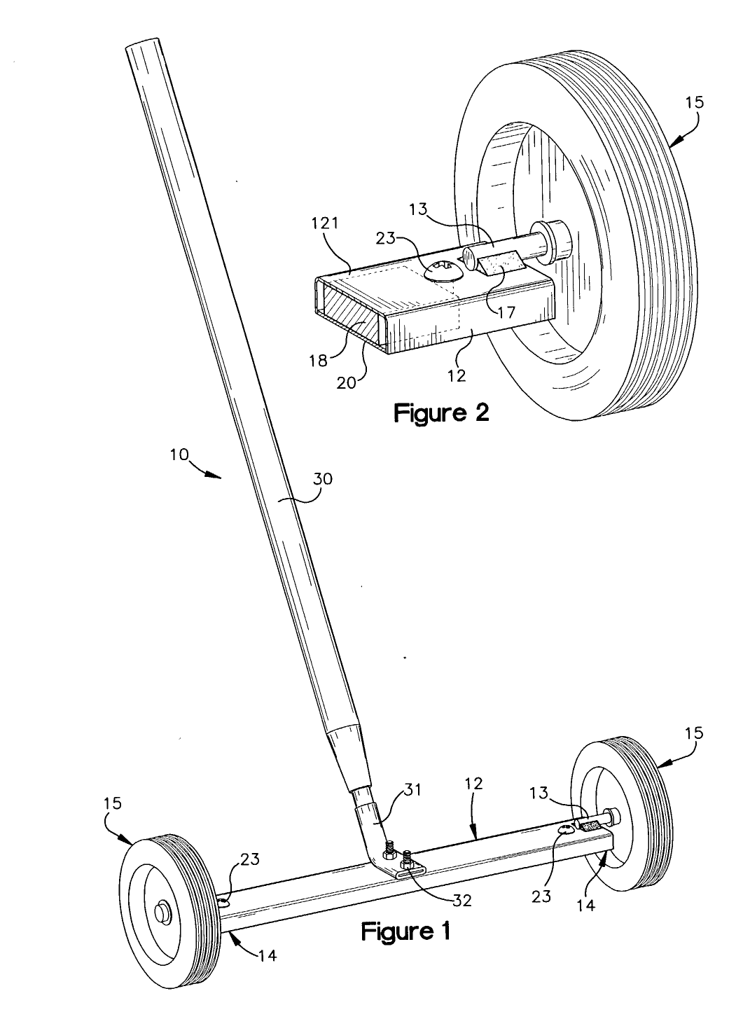

As shown in FIGS. 2, 3 and 4, one or more magnets 18 are located within channel 12 in an operative arrangement to attract ferrous objects, for example from underneath the channel as the tool is conveyed over a surface. In this example the magnets 18 are in the form of generally rectangular bar magnets. Although illustrated as two commonly sized magnets arranged side-by-side or end-to-end, a single piece magnet running substantially the length of the channel could also be used. The magnets 18 are held in position within the channel 12 by a plate 20, shown in cross-section in FIG. 5, which covers the open side of the channel from end-to-end. The plate 20 is secured to the channel by fasteners 23 which pass through the plate and the traverse the depth of the channel adjacent to the magnet(s) which are thereby fully encapsulated in the housing formed by the channel 12 and plate 20. As further described, this complete enclosure of the magnet(s) is advantageous for complete physical protection of the magnet(s) from mechanical damage and dirt.

As also shown in FIG. 5, the channel 12 is preferably in the form of a three-wall channel, having a top wall 121 and side walls 122 which extend generally perpendicular from the top wall 121, terminating at edges 123. Preferably the top wall 121 has a width dimension, measured as the distance from one side wall to the opposite side wall as shown in FIG. 5, which is greater than a width dimension of the side walls 122, measured as the distance from the top wall 121 to the terminal edges 123 of the side walls 122. This configuration provides an adequate housing for magnet bar stock which has a generally rectangular cross-section as shown in FIG. 2. Plate 20 preferably fits flush inside the side walls 122 at edges 123.

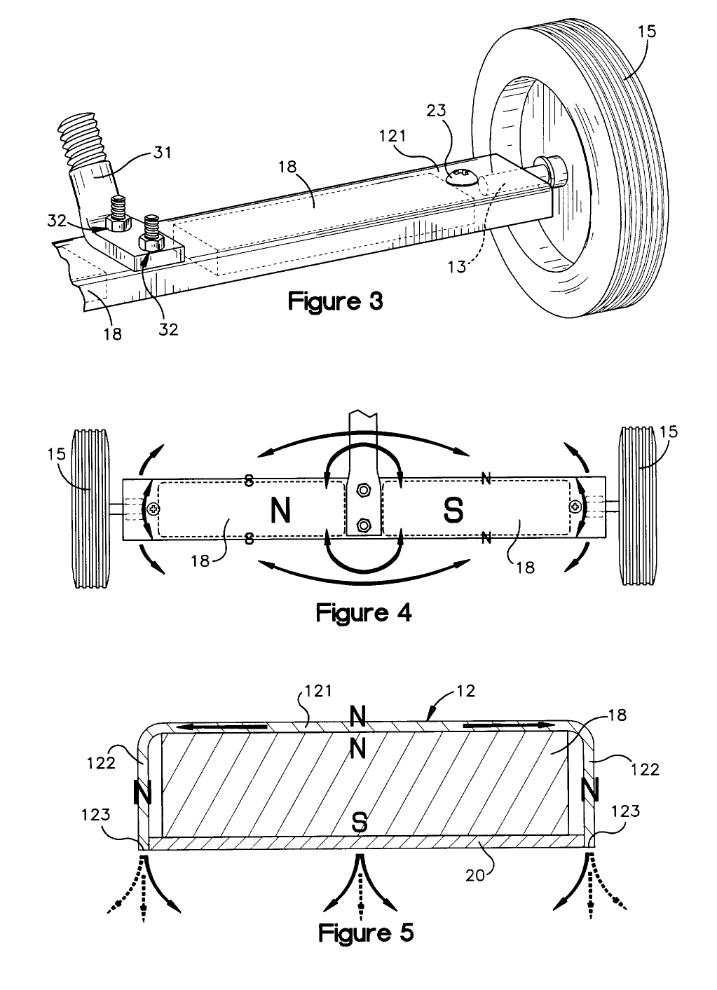

To optimize the magnetic flux pattern of the tool, plate 20 is ideally made of a non-ferrous material, such as plastic, aluminum or stainless steel, so as to not short the magnetic circuit within the channel 12. The enables the flux pattern shown in FIGS. 4 and 5, wherein the channel 12 serves to conduct the pole of the magnet in contact with the channel (N) through the top wall 121 and through the side walls 122, exiting at the side wall edges 123. The flux from the opposite pole of the magnet (S) passes through the non-magnetically conductive plate 20 between the edges 123 of the channel 12. In the double magnet configuration shown in FIGS. 3 and 4, the right and left magnets are preferably of opposite polarity, creating the cross-lateral flux pattern illustrated by the arrows. Plate 20 also functions as a physical shield to the underside of the magnet(s), providing protection from chipping, keeping the magnet(s) free from dirt and debris, and facilitating cleaning of the tool by easy removal of attracted objects from the smooth surface of the plate.

As shown in FIG. 2, axles 13 can be supported by and secured to the ends of the channel 12 by welds 17 formed on the top wall 121 of the channel. This arrangement provides a somewhat lower mounting height for the channel/magnet assembly relative to the contact surface of the wheels 15. Alternatively, as shown in FIG. 3, the axles 13 may be attached to an underside of channel top wall 121, on the inside of the channel proximate to magnet(s) 18. Other means of attachment of the axles 13 to the channel, such as through bearings or other mounting fixtures or by appropriate formation of the channel ends to receive a distal end of an axle are all within the scope of the invention.

Any type of manipulative device may be attached to the channel 12 to facilitate operation of the tool. As illustrated in FIGS. 1, 3 and 4, a handle 30 is attached to channel 12, for example at top wall 121 by fasteners or other means, with the handle fitting 31 being in the form of a tube, wire rod, or fitting such as a threaded fitting to engage an extension having a cooperating fitting such as a threaded receiving bolt or ferrule. In this example the handle fitting 31 is attached to channel 12 by fasteners 32. Other types of manipulative devices may be attached to the channel in similar manners, the common design aspect being that the channel 12 serves the multiple functions of the central support structure which houses and protects the magnet(s), provides points of attachment for conveyance such as the wheels and wheel axles, and provides a point or points of attachment for manipulative means such as a handle or grip; and the further function of the described magnetic flux direction control in cooperation with the plate 20.

1. A magnetic tool comprising:
a three-sided channel having a top wall and opposing side walls which extend from the top wall;
at least one magnet located substantially within the walls of the channel;
a plate which substantially covers an open side of the channel and the at least one magnet substantially within the channel;
conveyance means attached to the channel, and
manipulative means attached to the channel.

2. The magnetic tool of claim 1 wherein the top wall has a width dimension greater than a width dimension of the side walls.

3. The magnetic tool of claim 1 comprising two magnets located within the channel.

4. The magnetic tool of claim 3 wherein the two magnets are of opposite polarity.

5. The magnetic tool of claim 1 wherein the channel is magnetically conductive.

6. The magnetic tool of claim 1 wherein the channel is made of carbon steel and directs the magnetic flux away from the top wall and opposing side walls.

7. The magnetic tool of claim 1 wherein the plate which substantially covers the open side of the channel is magnetically non-conductive.

8. The magnetic tool of claim 1 wherein the plate fits within the side walls of the channel.

9. The magnetic tool of claim 1 wherein the plate is attached to the channel by at least one fastener.

10. The magnetic tool of claim 1 wherein the conveyance means attached to the channel is at least one wheel mounted on an axle attached to the channel.

11. The magnetic tool of claim 10 wherein the axle is attached to a top surface of the top wall of the channel.

12. The magnetic tool of claim 10 wherein the axle is attached to a bottom surface of the top wall of the channel.

13. The magnetic tool of claim 1 wherein the manipulative means includes a handle attachment fitting attached to the channel.

14. The magnetic tool of claim 1 wherein the manipulative means is attached at a midpoint of the channel.

15. A magnetic hand tool comprising:
A magnet housing formed by a three-sided channel and a plate which substantially covers an open side of the channel, the channel having a top wall and opposing side walls which extend from the top wall;
at least one magnet located in the housing formed by the channel and the plate;
a conveyance device attached to the channel;
and a manipulative device attached to the channel.

16. The magnetic tool of claim 15 wherein the top wall has a width dimension greater than a width dimension of the side walls.

17. The magnetic tool of claim 15 where the plate is attached to the top wall of the channel.

18. The magnetic tool of claim 15 wherein the channel is made of a magnetically conductive material which conducts magnetic flux from the at least one magnet through the top wall of the channel and through the side walls and terminating edges of the channel.

19. The magnetic tool of claim 15 wherein the plate is made of a magnetically non-conductive material.

20. The magnetic tool of claim 15 further comprising at least two magnets within the housing formed by the channel and the plate.

21. The magnetic tool of claim 20 wherein the at least two magnets are of opposite polarity.

22. The magnetic tool of claim 15 wherein the conveyance device attached to the channel is in the form of a wheel mounted upon an axle which is attached to the channel.

23. The magnetic tool of claim 15 wherein the manipulative device is in the form of a handle attached to the channel.

24. The magnetic tool of claim 15 wherein the manipulative device is in the form of a grip attached to a fitting which is secured to the channel.

25. A magnetic tool comprising:
a three-sided channel having a top wall and two opposing side walls oriented to extend downward from the top wall, the top wall being wider than a downward extent of the side walls;
at least one magnet located within the channel between the side walls and under the top wall;
a plate which extends a length of the channel, the plate being secured to the channel to encapsulate the at least one magnet within the channel;
a conveyance device attached to the channel for conveying the channel and the at least one magnet therein over a surface for attraction of ferrous articles, and
a handle attached to the channel for manipulating the magnetic tool.
